(19) United States
(12) Patent Application Publication
(10) Pub. No.: US 2022/0398990 A1
(43) Pub. Date: Dec. 15, 2022

(54) DISPLAY PANEL AND DRIVING METHOD THEREOF

(71) Applicant: TCL China Star Optoelectronics Technology Co., Ltd., Shenzhen (CN)

(72) Inventor: Gu HUANG, Shenzhen (CN)

(21) Appl. No.: 17/253,136

(22) PCT Filed: Apr. 7, 2020
(86) PCT No.: PCT/CN2020/083595

§ 371 Date: Dec. 17, 2020

(30) Foreign Application Priority Data
Mar. 6, 2020 (CN) 202010150239.2

(51) Int. Cl. G09G 3/36

(52) U.S. Cl. CPC G09G 3/3648; G09G 2370/00

(57) ABSTRACT

The present application provides a display panel and a driving method of the display panel. The display panel includes an output circuit board having multiple output terminals. The output terminal includes at least two output channels, one of which is electrically connected to one of data lines. At a first moment, a first portion of subpixels in an i-th row receive data signals input from the corresponding data lines. At a second time, a second portion of the sub-pixels in the i-th row excluding the first portion receive data signals input from the corresponding data lines.

### FIELD OF DISCLOSURE

The present application relates to a field of display technology and in particular, to a display panel and driving method thereof.

### DESCRIPTION OF RELATED ART

As televisions have larger screen sizes now, higher resolutions for screens are also required. Therefore, there has been a development trend for 8K or higher resolution display panels.

Current 8K or higher resolution LCD panels need to integrate more pixels in a glass substrate of limited size, but more pixels require more output channels on an output circuit board. Due to the limitation of a width of the output circuit board, an increase in the number of the output channels on the output circuit board results in an increase in production costs. Furthermore, a narrower width of a terminal on the output channel also causes a technical problem of poor signal transmission.

Therefore, there is an urgent need for a display panel which can solve the above technical problems.

### SUMMARY

The present application provides a display panel and a driving method thereof to solve a problem that there are some limitations to output channels on an output circuit board of a conventional high-resolution display device.

The present application provides a display panel, comprising:

a plurality of sub-pixels arranged in an array, the sub-pixels repeatedly arranged in rows and columns in the display panel, and any row of the sub-pixels comprising 2m sub-pixels, wherein m is a positive integer;

a plurality of scan lines configured to transmit scan signals, any row of the sub-pixels arranged corresponding to at least one of the scan lines, wherein one of the sub-pixels is electrically connected to one of the scan lines;

a plurality of data lines configured to transmit data signals, any column of the sub-pixels arranged corresponding to one of the data lines, wherein one of the sub-pixels is electrically connected to one of the data lines; and

an output circuit board comprising a plurality of output terminals, wherein the output terminal comprises at least two output channels, and one of the output channels is electrically connected to one of the data lines;

wherein at a first time, a first portion of the sub-pixels in the i-th row receive data signals input from the corresponding data lines; and at a second time, a second portion of the sub-pixels in the i-th row excluding the first portion receive data signals input from the corresponding data lines.

In the display panel of the present application,

the display panel comprises n rows of the sub-pixels and 2n scan lines;

any row of the sub-pixels is arranged corresponding to two of the scan lines, one of the sub-pixels is electrically connected to one of the scan lines, and two of the scan lines are arranged between adjacent two rows of the sub-pixels; and

wherein n is a positive integer.

In the display panel of the present application, a sub-pixels of the first portion of the sub-pixels in the i-th row are electrically connected to the (2i−1)-th scan line, and (2i−a) sub-pixels of the second portion of the sub-pixels in the i-th row excluding the first portion are electrically connected to the 2i-th scan line, wherein i and a are positive integers, and i is less than or equal to n.

According to the display panel of the present application, in the i-th row of the sub-pixels, the (2m−1)-th sub-pixel is electrically connected to the (2n−1)-th scan line, and the 2m-th sub-pixel is electrically connected to the 2n-th scan line.

According to the display panel of the present application, at the first time, the (2i−1)-th scan line inputs a high level signal, the 2i-th scan line inputs a low level signal, the first portion of the sub-pixels in the i-th row receive data signals input from the corresponding data lines, and the second portion of the sub-pixels in the i-th row receive no data signals input from the corresponding data lines; and

at the second time, the (2i−1)-th scan line inputs a low level signal, the 2i-th scan line inputs a high level signal, the first portion of the sub-pixels in the i-th row receive no data signals input from the corresponding data lines, and the second portion of the sub-pixels in the i-th row receive the data signals input from the corresponding data lines.

According to the display panel of the present application, the display panel comprises n rows of the sub-pixels and n scan lines; any row of the sub-pixels is arranged corresponding to one of the scan lines, and one of the sub-pixels is electrically connected to one of the scan lines.

According to the display panel of the present application, a plurality of first switches are arranged between a sub-pixels of the first portion of the sub-pixels in the i-th row and the corresponding i-th scan line, and a plurality of second switches are arranged between (2m−a) sub-pixels of the second portion of the sub-pixels in the i-th row and the corresponding i-th scan line;

at the first time, when the i-th scan line inputs a high level signal, the first switch is turned on, the second switch is turned off, and a sub-pixels in the first portion input data signals input from the corresponding data lines; and

at the second time, when the i-th scan line inputs a low level signal, the first switch is turned off, the second switch is turned on, and the (2m−a) sub-pixels of the second portion input data signals input from the corresponding data lines.

According to the display panel of the present application, any one of the output terminals at least comprises a first output channel and a second output channel, the first output channels are electrically connected to the odd-numbered data lines corresponding to the first portion of the sub-pixels in any row, and the second output channels are electrically connected to the even-numbered data lines corresponding to the second portion of the sub-pixels in any row.

According to the display panel of the present application, the display panel further comprises a plurality of third switches disposed between the first output channels and the odd-numbered data lines, and a plurality of fourth switches disposed between the second output channels and the even-numbered data lines;

at the first time, when the i-th scan line inputs a high level signal, the third switches are turned on, the fourth switches are turned off, and a sub-pixels of the first portion input data signals input from the corresponding data lines; and

at the second time, when the i-th scan line inputs a high level signal, the third switches are turned off, the fourth switches are turned on, and (2m−a) sub-pixels of the second portion input data signals input from the corresponding data lines.

The present application further provides a driving method of a display panel, comprising:

providing a plurality of sub-pixels arranged in an array, wherein the sub-pixels are repeatedly arranged in rows and columns in the display panel, any row of the sub-pixels comprises 2m sub-pixels, and m is a positive integer;

transmitting data signals to the corresponding data lines through a plurality of output terminals of an output circuit board, wherein the output terminal comprises at least two output channels, and one of the output channels is electrically connected to one of the data lines;

transmitting data signals to the sub-pixels in the corresponding columns through a plurality of data lines, wherein any column of the sub-pixels is arranged corresponding to one of the data lines, and one of the sub-pixels is electrically connected to one of the data lines; and

transmitting scan signals to the sub-pixels in the corresponding rows through a plurality of scan lines, turning on switches for the corresponding sub-pixels to input data signals to the corresponding sub-pixels, wherein any row of the sub-pixels is arranged corresponding to at least one scan line, and one of the sub-pixels is electrically connected to one of the scan lines;

wherein at a first time, a first portion of the sub-pixels in the i-th row receive data signals input from the corresponding data lines; and at a second time, a second portion of the sub-pixels in the i-th row excluding the first portion receive data signals input from the corresponding data lines.

In the driving method of the display panel according to the present application, the display panel comprises n rows of the sub-pixels and 2n scan lines;

any row of the sub-pixels is arranged corresponding to two of the scan lines, one of the sub-pixels is electrically connected to one of the scan lines, and two of the scan lines are arranged between adjacent two rows of the sub-pixels; and

wherein n is a positive integer.

In the driving method of the display panel according to present application, a sub-pixels of the first portion of the sub-pixels in the i-th row are electrically connected to the (2i−1)-th scan line, (2i−a) sub-pixels of the second portion of the sub-pixels in the i-th row excluding the first portion are electrically connected to the 2i-th scan line; wherein i and a are positive integers, and i is less than or equal to n.

According to the driving method of the display panel of the present application, in the i-th row of the sub-pixels, the (2m−1)-th sub-pixel is electrically connected to the (2n−1)-th scan line, and the 2m-th sub-pixel is electrically connected to the 2n-th scan line.

In the driving method of the display panel according to the present application, at the first time, the (2i−1)-th scan line inputs a high level signal, and the 2i-th scan line inputs a low level signal, the first portion of the sub-pixels in the i-th row receive data signals input from the corresponding data lines, and the second portion of the sub-pixels in the i-th row receive no data signals input from the corresponding data lines; and

at the second time, the (2i−1)-th scan line inputs a low level signal, and the 2i-th scan line inputs a high level signal, the first portion of the sub-pixels in the i-th row receive no data signals input from the corresponding data lines, and the second portion of the sub-pixels in the i-th row receive the data signals input from the corresponding data lines.

In the driving method of the display panel according to the present application, the display panel comprises n rows of the sub-pixels and n scan lines; any row of the sub-pixels is arranged corresponding to one of the scan lines, and one of the sub-pixels is electrically connected to one of the scan lines.

In the driving method of the display panel according to the present application, a plurality of first switches are arranged between a sub-pixels of the first portion of the sub-pixels in the i-th row and the corresponding i-th scan line, and a plurality of second switches are arranged between (2m−a) sub-pixels of the second portion of the sub-pixels in the i-th row and the corresponding i-th scan line;

at the first time, when the i-th scan line inputs a high level signal, the first switch is turned on, and the second switch is turned off, a sub-pixels in the first portion input data signals input from the corresponding data lines; and

at the second time, when the i-th scan line inputs a low level signal, the first switch is turned off, the second switch is turned on, and the (2m−a) sub-pixels of the second portion input data signals input from the corresponding data lines.

In the driving method of the display panel according to the present application, any one of the output terminals at least comprises a first output channel and a second output channel, the first output channels are electrically connected to the odd-numbered data lines corresponding to the first portion of the sub-pixels in any row, and the second output channels are electrically connected to the even-numbered data lines corresponding to the second portion of the sub-pixels in any row.

In the driving method of the display panel according to the present application, the display panel further comprises a plurality of third switches disposed between the first output channels and the odd-numbered data lines, and a plurality of fourth switches disposed between the second output channels and the even-numbered data lines;

at the first time, when the i-th scan line inputs a high level signal, the third switches are turned on, the second switches are turned off, and a sub-pixels of the first portion input data signals input from the corresponding data lines; and

at the second time, when the i-th scan line inputs a high level signal, the third switches are turned off, the fourth switches are turned on, and (2m−a) sub-pixels of the second portion input data signals input from the corresponding data lines.

Advantages of the Present Application:

The present application reduces the number of the output channels required by a high-resolution display device by electrically connecting one output terminal to at least two data lines and driving the sub-pixels in the same row at different times, thereby solving the problem of poor signal transmission in conventional high-resolution display devices and lowering the production costs.

### BRIEF DESCRIPTION OF DRAWINGS

Hereinafter, a description in conjunction with the accompanying figures is provided to more clearly illustrate the embodiments of the present disclosure, which will ease the understanding of the technical solutions and other beneficial effects of the present application.

FIG. 1 is a schematic view illustrating a first pixel structure of a display panel according to the present application.

FIG. 2 is a schematic view illustrating a second pixel structure of the display panel according to the present application.

FIG. 3 is a schematic view illustrating a third pixel structure of the display panel according to the present application.

FIG. 4 is a process flow diagram illustrating a driving method of the display panel.

### DETAILED DESCRIPTION OF EMBODIMENTS

In order to make the purposes, technical solutions and effects of the present application clearer and specific, the present application is described in detail below with reference to the accompanying drawings and embodiments. It should be noted that the specific embodiments described herein are only used to explain the present application, and are not intended to limit the present application.

At present, 8K or higher resolution liquid crystal display (LCD) panels need to integrate more pixels on a glass substrate of limited size, but more pixels requires more output channels on an output circuit board. Due to a limitation of a width of the output circuit board, an increase in the number of the output channels on the output circuit board causes an increase in production costs, and at the same time, a terminal with a narrower width on the output channel results in a problem of poor signal transmission. The present application provides the following technical solutions to solve the above technical problems.

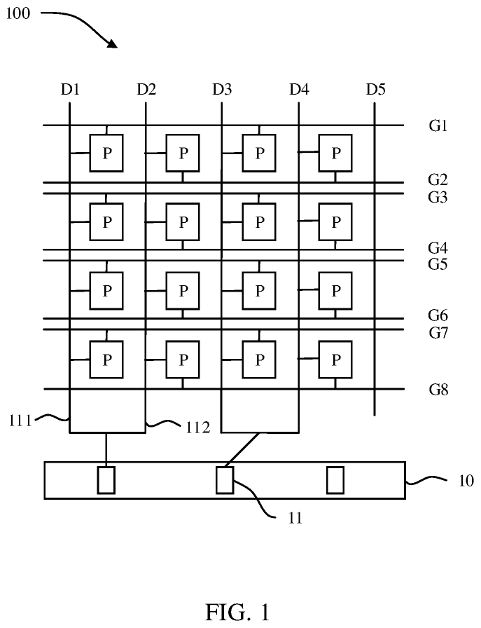

Please refer to FIGS. 1 to 3. The present application provides a display panel 100, comprising:

a plurality of sub-pixels arranged in an array, wherein the sub-pixels are, for example, pixels P arranged in an array in FIGS. 1 to 3, the sub-pixels are repeatedly arranged in rows and columns in the display panel 100, and any row of the sub-pixels comprises 2m sub-pixels, wherein m is a positive integer;

a plurality of scan lines configured to transmit scan signals, wherein the scan lines are, for example, scan lines G1 to G8 in FIGS. 1 to 3, any row of the sub-pixels is arranged corresponding to at least one of the scan lines, and one of the sub-pixels is electrically connected to one of the scan lines;

a plurality of data lines configured to transmit data signals, wherein the data lines are, for example, data lines D1 to D5 in FIGS. 1 to 3, any column of the sub-pixels is arranged corresponding to one of the data lines, and one of the sub-pixels is electrically connected to one of the data lines; and

an output circuit board 10 comprising a plurality of output terminals 11, wherein the output terminal 11 comprises at least two output channels, and one of the output channels is electrically connected to one of the data lines;

wherein at a first time, a first portion of the sub-pixels in the i-th row receive data signals input from the corresponding data lines; and at a second time, a second portion of the sub-pixels in the i-th row excluding the first portion receive data signals input from the corresponding data lines.

The present application reduces the number of the output channels required by a high-resolution display device by electrically connecting one output terminal 11 to at least two data lines and driving the sub-pixels in the same row at different times, thus solving a problem of poor signal transmission in conventional high-resolution display devices and lowering production costs.

The following description is provided to explain the technical solution of the present application based on specific embodiments.

### First Embodiment

Referring to FIG. 1, the display panel 100 comprises n rows of the sub-pixels and 2n scan lines.

In the present embodiment, any row of the sub-pixels is arranged corresponding to two of the scan lines, one of the sub-pixels is electrically connected to one of the scan lines, and two of the scan lines are arranged between adjacent two rows of the sub-pixels, wherein n is a positive integer.

For example, the first row of the sub-pixels is connected to the first scan line G1 and the second scan line G2, the second row of the sub-pixels is connected to the third scan line G3 and the fourth scan line G4, and connection of the subsequent rows of the sub-pixels can be deduced by analogy.

In the present embodiment, a sub-pixels of the first portion of the sub-pixels in the i-th row are electrically connected to the (2i−1)-th scan line, and (2i−a) sub-pixels of the second portion of the sub-pixels in the i-th row excluding the first portion are electrically connected to the 2i-th scan line; wherein i and a are positive integers, and i is less than or equal to n.

For example, any row of the sub-pixels comprises 1366 sub-pixels. For the first row of the sub-pixels, there are 683 sub-pixels connected to the first scan line G1, and the rest 683 sub-pixels in the first row are connected to the second scan line G2. In the present embodiment, the number of the sub-pixels in the first portion and the number of the sub-pixels in the second portion can be unequal; the present application is not limited in this regard.

In the present embodiment, in the i-th row of the sub-pixels, the (2m−1)-th sub-pixel is electrically connected to the (2n−1)-th scan line, and the 2m-th sub-pixel is electrically connected to the 2n-th scan line.

Referring to FIG. 1, for the first row of the sub-pixels, the sub-pixels in the odd-numbered columns are connected to the first scan line G1, and the sub-pixels in the even-numbered columns are connected to the second scan line G2. That is, the sub-pixels in odd-numbered columns such as numbers 1, 3, 5, and 7 are connected to the first scan line G1, and the sub-pixels in even-numbered columns such as numbers 2, 4, 6, and 8 are connected to the second scan line G2.

Based on the foundation of the above embodiment, the present application can also connect the sub-pixels from the 1-st to the 683-rd columns to the first scan line G1, and connect the sub-pixels from the 684-th to the 1366-th columns to the second scan line G2.

Referring to FIG. 1, the output circuit board 10 comprises a plurality of output terminals 11. Any one of the output terminals at least comprises a first output channel 11 and a second output channel 12.

In the present embodiment, the first output channels 111 are electrically connected to the odd-numbered data lines in the display panel 100, and the second output channels 112 are electrically connected to the even-numbered data lines in the display panel. The number of the output terminals 11 is half of the number of the data lines.

In the present embodiment, an output switch of any of the scan lines can be an N-type thin film transistor or a P-type thin film transistor. The N-type thin film transistor is taken as an example for description below.

At the first time, the (2i−1)-th scan line inputs a high level signal, and the 2i-th scan line inputs a low level signal, the first portion of the sub-pixels in the i-th row receive data signals input from the corresponding data lines, and the second portion of the sub-pixels in the i-th row receive no data signals input from the corresponding data lines; and

at the second time, the (2i−1)-th scan line inputs a low level signal, and the 2i-th scan line inputs a high level signal, the first portion of the sub-pixels in the i-th row receive no data signals input from the corresponding data lines, and the second portion of the sub-pixels in the i-th row receive the data signals input from the corresponding data lines.

For example, at the first time, the first scan line G1 inputs a high level signal, the output switch of the first scan line G1 is turned on, the second scan line inputs a low level signal, the output switch of the second scan line G2 is turned off, the first portion of the sub-pixels in the first row receive data signals input from the corresponding data lines, and the second portion of the sub-pixels in the first row receive no data signals input from the corresponding data lines.

At the second time, the first scan line G1 inputs a low level signal, the output switch of the first scan line G1 is turned off, the second scan line inputs a high level signal, the output switch of the scan line G2 is turned on, the first portion of the sub-pixels in the first row receive no data signals input from the corresponding data lines, and the second portion of the sub-pixels in the first row receive the data signals input from the corresponding data lines.

The present application uses two different scan lines to drive the same row of the sub-pixels, and connects two columns of the data lines to the same output terminal 11 to drive the same row of the sub-pixels at different times. On the premise that the display performance and signal transmission quality of the display panel 100 are ensured, a high-resolution display device requires fewer output channels, thus solving the problem of poor signal transmission in conventional high-resolution display devices.

### Second Embodiment

The present embodiment is the same as or similar to the first embodiment, except for the following:

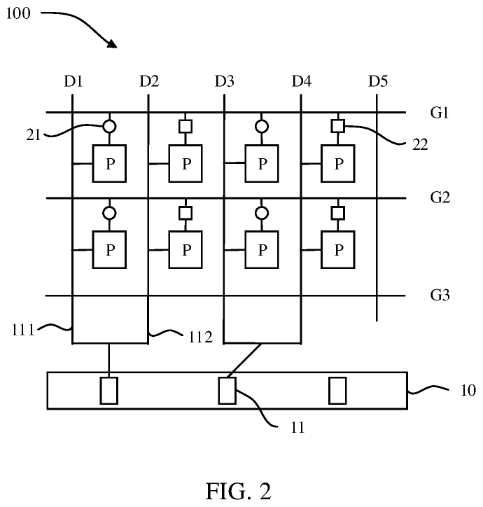

Referring to FIG. 2, the display panel 100 comprises n rows of the sub-pixels and n scan lines.

In the present embodiment, any row of the sub-pixels is arranged corresponding to one of the scan lines, and one of the sub-pixels is electrically connected to one of the scan lines. The above connection method is the same as that of conventional techniques.

For example, the first row of the sub-pixels is connected to the first scan line G1, the second row of the sub-pixels is connected to the second scan line G2, and connection of the subsequent rows of the sub-pixels can be deduced by analogy.

In the present embodiment, a plurality of first switches 21 are arranged between a sub-pixels of the first portion of the sub-pixels in the i-th row and the corresponding i-th scan line, and a plurality of second switches 22 are arranged between (2m−a) sub-pixels of the second portion of the sub-pixels in the i-th row and the corresponding i-th scan line.

For example, for any row of the sub-pixels, the sub-pixels in the odd-numbered columns are the first portion, while for any row of the sub-pixels, the sub-pixels in the even-numbered columns are the second portion. For the first row of the sub-pixels, the first switches 21 are disposed between the sub-pixels of the odd-numbered columns, such as numbers 1, 3, 5, 7, and the first scan line G1; the second switches 22 are disposed between the sub-pixels of the even-numbered columns, such as numbers 2, 4, 6, 8, and the first scan line G1.

In the present embodiment, the first output channels 111 are electrically connected to the odd-numbered data lines corresponding to the first portion of the sub-pixels in any row, and the second output channels 112 are electrically connected to the even-numbered data lines corresponding to the second portion of the sub-pixels in any row.

At the first time, when the i-th scan line inputs a high level signal, the first switch 21 is turned on, the second switch 22 is turned off, and a sub-pixels in the first portion input data signals input from the corresponding data lines; and

at the second time, when the i-th scan line inputs a low level signal, the first switch 21 is turned off, the second switch 22 is turned on, and the (2m−a) sub-pixels of the second portion input data signals input from the corresponding data lines.

In the present embodiment, the first switch 21 can be one of an N-type thin film transistor and a P-type thin film transistor, and the second switch 22 can be the other one of the N-type thin film transistor and the P-type thin film transistor, which is not the same type as the first switch 21. The following description takes as an example that the first switch 21 is the N-type thin film transistor, and the second switch 22 is the P-type thin film transistor.

For example, at the first time, when the first scan line G1 inputs a high level signal, the first switch 21 is turned on, the second switch 22 is turned off, and a sub-pixels in the first portion input data signals input from the corresponding data lines.

At the second time, when the first scan line inputs a low level signal, the first switch 21 is turned off, the second switch 22 is turned on, and the sub-pixels of the second portion input data signals input from the corresponding data lines.

In the present application, the same row of the sub-pixels in different columns are provided with the first switches 21 and the second switches 22, and different level signals are input by the corresponding scan lines, so that the sub-pixels in the same row can be driven at different times. Compared with the first embodiment, the present application does not need to increase the number of the scan lines, and only needs to add a thin film transistor switch to any sub-pixel. Accordingly, on the premise that display performance and signal transmission quality of the display panel 100 are ensured, fewer output channels are required for a high-resolution display device, so the problem of poor signal transmission in the conventional high-resolution display device is eliminated.

### Third Embodiment

The present embodiment is the same as or similar to the first embodiment and the second embodiment, except for the following.

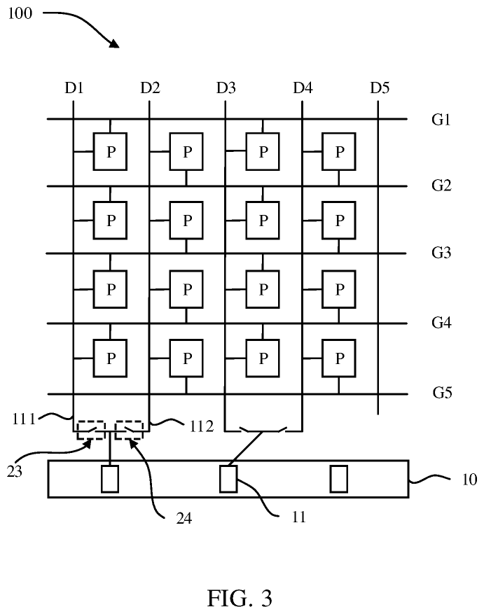

Referring to FIG. 3, the display panel 100 comprises n rows of the sub-pixels and 2n scan lines.

In the present embodiment, any row of the sub-pixels is arranged corresponding to one of the scan lines, and one of the sub-pixels is electrically connected to one of the scan lines. The above connection method is the same as that of the conventional techniques.

In the present embodiment, the display panel 100 further comprises a plurality of third switches 23 disposed between the first output channels 111 and the odd-numbered data lines, and a plurality of fourth switches 24 disposed between the second output channels 112 and the even-numbered data lines.

In the present embodiment, at the first time, when the i-th scan line inputs a high level signal, the third switches 23 are turned on, the fourth switches are turned off, and a sub-pixels of the first portion input data signals input from the corresponding data lines.

At the second time, when the i-th scan line inputs a high level signal, the third switches 23 are turned off, the fourth switches 24 are turned on, and (2m−a) sub-pixels of the second portion input data signals input from the corresponding data lines.

In the present embodiment, the display panel 100 further comprises a signal sensor (not illustrated) connected to the third switch 23 and the fourth switch 24. When the signal sensor detects that the scan line outputs a high-level signal, the signal sensor transmits an opening signal to the third switch 23, so the third switch 23 is turned on, and the signal sensor transmits a closing signal to the fourth switch 24, so the third switch 23 is turned off. When the signal sensor detects that the scan line outputs a low-level signal, the signal sensor transmits a closing signal to the third switch 23, so the third switch 23 is turned off, and the signal sensor transmits an opening signal to the fourth switch 24, so the third switch 23 is turned on.

For example, at the first moment, when the first scan line inputs a high-level signal, the signal sensor transmits an opening signal to the third switch 23, so the third switch 23 is turned on, and the signal sensor transmits a closing signal to the fourth switch 24, so the third switch 23 is turned off, and the sub-pixels of the first portion input data signals input from the corresponding odd-numbered data lines.

At the second time, when the first scan line inputs a high level signal, the signal sensor transmits a closing signal to the third switch 23, so the third switch 23 is turned off, and the signal sensor transmits an opening signal to the fourth switch 24, so the third switch 23 is turned on. The sub-pixels of the second portion input data signals input from the corresponding even-numbered data lines.

In the present application, the third switch 23 and the fourth switch 24 are provided on different output channels of the same output terminal 11. The third switches 23 and the fourth switch 24 are turned on separately by the different-level signals input at different times by the scan lines in the corresponding rows, so as to drive the sub-pixels in the same row at different times. On the premise that the display performance and the signal transmission quality of the display panel 100 are ensured, a high-resolution display device requires fewer output channels, thus solving the problem of poor signal transmission in the conventional high-resolution display devices.

In the above embodiment, any row of the sub-pixels can be driven by three or more scan lines, and the number of the channels for the corresponding output terminal should be the same as the number of the scan lines connected to one row of the sub-pixels.

For example, the sub-pixels in the 1-st, 4-th, 7-th, 10-th, . . . , (3k−2)-th columns are connected to the first scan line G1, the data lines corresponding to the sub-pixels in the 1-st, 4-th, 7-th, 10-th, . . . , (3k−2)-th columns are connected to a first channel of any output terminal, the sub-pixels in the 2-nd, 5-th, 8-th, 11-th, . . . , (3k−1)-th columns are connected to the second scan line G2, and the data lines corresponding to the sub-pixels in the 2-nd, 5-th, 8-th, 11-th, . . . , and (3k−1)-th columns are connected to a second channel of any output terminal. The sub-pixels in the 3-rd, 6-th, 9-th, 12-th, . . . , 3k-th columns are connected to the third scan line G3, and the data lines corresponding to the sub-pixels in the 3-rd, 6-th, 9-th, 12-th, . . . , 3k-th columns are connected to a third channel of any output terminal. In the present embodiment, the first scan line G1, the second scan line G2, and the third scan line G3 can be provided in different layers.

Therefore, the above embodiment also enables the sub-pixels in the same row to be driven at different times, thus further reducing the number of the output channels required for high-resolution display devices.

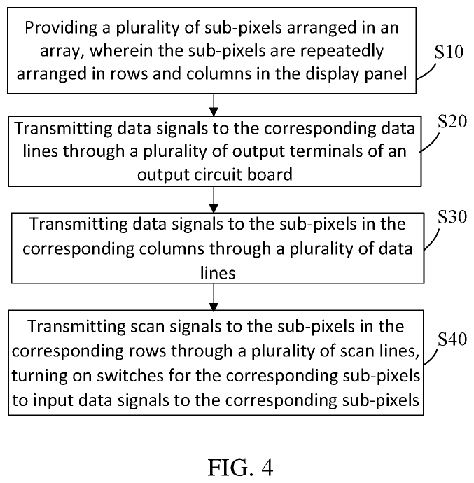

Referring to FIG. 4, the present application further provides a driving method of a display panel, comprising:

S10: providing a plurality of sub-pixels arranged in an array, wherein the sub-pixels are repeatedly arranged in rows and columns in the display panel, any row of the sub-pixels comprises 2m sub-pixels, and m is a positive integer;

S20: transmitting data signals to the corresponding data lines through a plurality of output terminals of an output circuit board, wherein the output terminal comprises at least two output channels, and one of the output channels is electrically connected to one of the data lines;

S30: transmitting data signals to the sub-pixels in the corresponding columns through multiple data lines, wherein any column of the sub-pixels is arranged corresponding to one of the data lines, and one of the sub-pixels is electrically connected to one of the data lines; and

S40: transmitting scan signals to the sub-pixels in the corresponding rows through a plurality of scan lines, turning on switches for the corresponding sub-pixels to input data signals to the corresponding sub-pixels, wherein any row of the sub-pixels is arranged corresponding to at least one scan line, and one of the sub-pixels is electrically connected to one of the scan lines.

In the present embodiment, at a first time, a first portion of the sub-pixels in the i-th row receive data signals input from the corresponding data lines; and at a second time, a second portion of the sub-pixels in the i-th row excluding the first portion receive data signals input from the corresponding data lines.

For the driving method in the present embodiment, please refer to the first to the third embodiments. The driving method of the display panel of the present application is the same as or similar to the working principles of the above display panel, so a detailed description is omitted herein for brevity.

The present application provides a display panel and a driving method thereof. The display panel comprises a plurality of sub-pixels arranged in an array, a plurality of scan lines, a plurality of data lines, and an output circuit board including a plurality of output terminals. The output terminal comprises at least two output channels, and one of the output channels is electrically connected to one of the data lines. At a first time, a first portion of the sub-pixels in the i-th row receive data signals input from the corresponding data lines; and at a second time, a second portion of the sub-pixels in the i-th row excluding the first portion receive data signals input from the corresponding data lines. The present application reduces the number of the output channels required by a high-resolution display device by electrically connecting one output terminal to at least two data lines and driving the sub-pixels in the same row at different times, thus solving the problem of poor signal transmission in conventional high-resolution display devices and lowering production costs.

It can be understood that, for those of ordinary skill in the art, equivalent replacements or changes can be made according to the technical solutions and inventive concepts of the present application, and all such changes or replacements should fall within the protection scope of the claims appended to the present application.

What is claimed is:

1. A display panel, comprising:
a plurality of sub-pixels arranged in an array, the sub-pixels repeatedly arranged in rows and columns in the display panel, and any row of the sub-pixels comprising 2m sub-pixels, wherein m is a positive integer;
a plurality of scan lines configured to transmit scan signals, any row of the sub-pixels arranged corresponding to at least one of the scan lines, wherein one of the sub-pixels is electrically connected to one of the scan lines;
a plurality of data lines configured to transmit data signals, any column of the sub-pixels arranged corresponding to one of the data lines, wherein one of the sub-pixels is electrically connected to one of the data lines; and
an output circuit board comprising a plurality of output terminals, wherein the output terminal comprises at least two output channels, and one of the output channels is electrically connected to one of the data lines;
wherein at a first time, a first portion of the sub-pixels in the i-th row receive data signals input from the corresponding data lines; and at a second time, a second portion of the sub-pixels in the i-th row excluding the first portion receive data signals input from the corresponding data lines.

2. The display panel according to claim 1, wherein the display panel comprises n rows of the sub-pixels and 2n scan lines;
any row of the sub-pixels is arranged corresponding to two of the scan lines, one of the sub-pixels is electrically connected to one of the scan lines, and two of the scan lines are arranged between adjacent two rows of the sub-pixels; and
wherein n is a positive integer.

3. The display panel according to claim 2, wherein a sub-pixels of the first portion of the sub-pixels in the i-th row are electrically connected to the (2i−1)-th scan lines, and (2i−a) sub-pixels of the second portion of the sub-pixels in the i-th row excluding the first portion are electrically connected to the 2i-th scan line;
wherein i and a are positive integers, and i is less than or equal to n.

4. The display panel according to claim 3, wherein in the i-th row of the sub-pixels, the (2m−1)-th sub-pixel is electrically connected to the (2n−1)-th scan line, and the 2m-th sub-pixel is electrically connected to the 2n-th scan line.

5. The display panel according to claim 3, wherein at the first time, the (2i−1)-th scan line inputs a high level signal, the 2i-th scan line inputs a low level signal, the first portion of the sub-pixels in the i-th row receive data signals input from the corresponding data lines, and the second portion of the sub-pixels in the i-th row receive no data signals input from the corresponding data lines; and
at the second time, the (2i−1)-th scan line inputs a low level signal, the 2i-th scan line inputs a high level signal, the first portion of the sub-pixels in the i-th row receive no data signals input from the corresponding data lines, and the second portion of the sub-pixels in the i-th row receive the data signals input from the corresponding data lines.

6. The display panel according to claim 1, wherein the display panel comprises n rows of the sub-pixels and n scan lines;
any row of the sub-pixels is arranged corresponding to one of the scan lines, and one of the sub-pixels is electrically connected to one of the scan lines.

7. The display panel according to claim 6, wherein a plurality of first switches are arranged between a sub-pixels of the first portion of the sub-pixels in the i-th row and the corresponding i-th scan line, and a plurality of second switches are arranged between (2m−a) sub-pixels of the second portion of the sub-pixels in the i-th row and the corresponding i-th scan line;
at the first time, when the i-th scan line inputs a high level signal, the first switch is turned on, the second switch is turned off, and a sub-pixels in the first portion input data signals input from the corresponding data lines; and
at the second time, when the i-th scan line inputs a low level signal, the first switch is turned off, the second switch is turned on, and the (2m−a) sub-pixels of the second portion input data signals input from the corresponding data lines.

8. The display panel according to claim 6, wherein any one of the output terminals at least comprises a first output channel and a second output channel, the first output channels are electrically connected to the odd-numbered data lines corresponding to the first portion of the sub-pixels in any row, and the second output channels are electrically connected to the even-numbered data lines corresponding to the second portion of the sub-pixels in any row.

9. The display panel according to claim 8, wherein the display panel further comprises a plurality of third switches disposed between the first output channels and the odd-numbered data lines, and a plurality of fourth switches disposed between the second output channels and the even-numbered data lines;
at the first time, when the i-th scan line inputs a high level signal, the third switches are turned on, the fourth switches are turned off, and a sub-pixels of the first portion input data signals input from the corresponding data lines; and
at the second time, when the i-th scan line inputs a high level signal, the third switches are turned off, the fourth switches are turned on, and (2m−a) sub-pixels of the second portion input data signals input from the corresponding data lines.

10. A driving method of a display panel, comprising:
providing a plurality of sub-pixels arranged in an array, wherein the sub-pixels are repeatedly arranged in rows and columns in the display panel, any row of the sub-pixels comprises 2m sub-pixels, and m is a positive integer;
transmitting data signals to the corresponding data lines through a plurality of output terminals of an output circuit board, wherein the output terminal comprises at least two output channels, and one of the output channels is electrically connected to one of the data lines;
transmitting data signals to the sub-pixels in the corresponding columns through multiple data lines, wherein any column of the sub-pixels is arranged corresponding to one of the data lines, and one of the sub-pixels is electrically connected to one of the data lines; and
transmitting scan signals to the sub-pixels in the corresponding rows through a plurality of scan lines, turning on switches for the corresponding sub-pixels to input data signals to the corresponding sub-pixels, wherein any row of the sub-pixels is arranged corresponding to at least one scan line, and one of the sub-pixels is electrically connected to one of the scan lines;
wherein at a first time, a first portion of the sub-pixels in the i-th row receive data signals input from the corresponding data lines; and at a second time, a second portion of the sub-pixels in the i-th row excluding the first portion receive data signals input from the corresponding data lines.

11. The driving method of the display panel according to claim 10, wherein the display panel comprises n rows of the sub-pixels and 2n scan lines;
any row of the sub-pixels is arranged corresponding to two of the scan lines, one of the sub-pixels is electrically connected to one of the scan lines, and two of the scan lines are arranged between adjacent two rows of the sub-pixels; and
wherein n is a positive integer.

12. The driving method of the display panel according to claim 11, wherein a sub-pixels of the first portion of the sub-pixels in the i-th row are electrically connected to the (2i−1)-th scan line, (2i−a) sub-pixels of the second portion of the sub-pixels in the i-th row excluding the first portion are electrically connected to the 2i-th scan line;
wherein i and a are positive integers, and i is less than or equal to n.

13. The driving method of the display panel according to claim 12, wherein in the i-th row of the sub-pixels, the (2m−1)-th sub-pixel is electrically connected to the (2n−1)-th scan line, and the 2m-th sub-pixel is electrically connected to the 2n-th scan line.

14. The driving method of the display panel according to claim 12, wherein at the first time, the (2i−1)-th scan line inputs a high level signal, and the 2i-th scan line inputs a low level signal, the first portion of the sub-pixels in the i-th row receive data signals input from the corresponding data lines, and the second portion of the sub-pixels in the i-th row receive no data signals input from the corresponding data lines; and
at the second time, the (2i−1)-th scan line inputs a low level signal, and the 2i-th scan line inputs a high level signal, the first portion of the sub-pixels in the i-th row receive no data signals input from the corresponding data lines, and the second portion of the sub-pixels in the i-th row receive the data signals input from the corresponding data lines.

15. The driving method of the display panel according to claim 10, wherein the display panel comprises n rows of the sub-pixels and n scan lines;
any row of the sub-pixels is arranged corresponding to one of the scan lines, and one of the sub-pixels is electrically connected to one of the scan lines.

16. The driving method of the display panel according to claim 15, wherein a plurality of first switches are arranged between a sub-pixels of the first portion of the sub-pixels in the i-th row and the corresponding i-th scan line, and a plurality of second switches are arranged between (2m−a) sub-pixels of the second portion of the sub-pixels in the i-th row and the corresponding i-th scan line;
at the first time, when the i-th scan line inputs a high level signal, the first switch is turned on, and the second switch is turned off, a sub-pixels in the first portion input data signals input from the corresponding data lines; and
at the second time, when the i-th scan line inputs a low level signal, the first switch is turned off, the second switch is turned on, and the (2m−a) sub-pixels of the second portion input data signals input from the corresponding data lines.

17. The driving method of the display panel according to claim 15, wherein any one of the output terminals at least comprises a first output channel and a second output channel, the first output channels are electrically connected to the odd-numbered data lines corresponding to the first portion of the sub-pixels in any row, and the second output channels are electrically connected to the even-numbered data lines corresponding to the second portion of the sub-pixels in any row.

18. The driving method of the display panel according to claim 17, wherein the display panel further comprises a plurality of third switches disposed between the first output channels and the odd-numbered data lines, and a plurality of fourth switches disposed between the second output channels and the even-numbered data lines;
at the first time, when the i-th scan line inputs a high level signal, the third switches are turned on, the second switches are turned off, and a sub-pixels of the first portion input data signals input from the corresponding data lines; and
at the second time, when the i-th scan line inputs a high level signal, the third switches are turned off, the fourth switches are turned on, and (2m−a) sub-pixels of the second portion input data signals input from the corresponding data lines.
